(19) United States
(12) Patent Application Publication
(10) Pub. No.: US 2008/0243934 A1
(43) Pub. Date: Oct. 2, 2008

(54) Method and system for licensing of digital assets

(76) Inventor: Augustine Fou, New York, NY (US)

Correspondence Address: CHARLES A. RATTNER, 23 ADAMS LANE, NORWALK, CT, 06850-1314, US

(21) Appl. No.: 12/080,309

(22) Filed: Apr. 2, 2008

Related U.S. Application Data
(60) Provisional application No. 60/921,359, filed on Apr. 2, 2007.

(51) Int. Cl. G06F 17/00

(52) U.S. Cl. 707/104.1; 707/E17.044

(57) ABSTRACT

A website or other publicly-accessible domain includes the ability to easily search for and license stock photography.

### CROSS-REFERENCE TO RELATED APPLICATIONS

This application claims priority under 35 U.S.C. §119 to U.S. Provisional Patent Application Ser. No. 60/921,359 entitled “METHOD AND SYSTEM FOR LICENSING OF DIGITAL ASSETS” filed in the name of Augustine Fou on Apr. 2, 2007, the entirety of which is herein incorporated by reference.

### TECHNICAL FIELD

This invention relates generally to the field of distributing stock photography. More particularly, this disclosure relates to finding images suitable to be licensed for a particular purpose, effecting the license, and archiving proof of such license for future public inspection.

### BACKGROUND OF THE DISCLOSURE

The stock photography industry is estimated to be $20 billion world-wide. There are a handful of big “stock houses” that historically have made contracts with many photographers to help them sell their work as stock images. However there are many drawbacks to the existing system. Stock houses share relatively small amounts of revenue back to the original photographer, in the form of royalties or the like. Also, searching for the right image has mostly been inaccessible to the image buyers themselves and must be performed by image researchers. Additionally, purchasing a license to use an image has been very expensive and, therefore, generally prohibitive to smaller companies and designers. Finally, licenses for stock photography have traditionally extremely long and restrictive.

In recent years, online repositories of photos have been created, the largest and best known of which include FLICKR, ISTOCKPHOTO, SMUGMUG, DEVIANTART, and others. Some of these are purely recreational for sharing family photos. Others have added “stock photography” features to enable image owners to sell their images. FLICKR.COM, for example, has many times the number of photos in inventory compared with GETTY, the largest of the stock houses. However, businesses can not typically make use of these images as stock photos because the search interface provided by FLICKR is primitive, and there are no standardized methods for obtaining and paying for licenses, or showing proof that a license was indeed obtained for a particular image or similar digital asset.

### SUMMARY OF THE DISCLOSURE

The present invention, sometimes referred to herein as PICTURESANDBOX, helps image buyers more efficiently search and find images that are suitable for use as stock images. It enables them to “save their work” through saved searches and roll-back to prior saved searches. It creates lightboxes through drag and drop of selected images, which are shareable with clients, who in turn can give simple ratings to tell the image buyer which images they like or dislike. All original images are watermarked with the image owner's copyright and other essential information. Once the license is agreed to by both parties, PICTURESANDBOX accepts payment from the image buyer and passes net proceeds to the image owner.

### BRIEF DESCRIPTION OF THE ACCOMPANYING DRAWINGS

Further aspects of the present disclosure will be more readily appreciated upon review of the detailed description of its various embodiments, described below, when taken in conjunction with the accompanying drawings, of which:

FIG. 1 is an exemplary search window and results for PICTURESANDBOX;

FIG. 2 displays exemplary shared lightboxes with user ratings; and

FIG. 3 displays an exemplary code for installing lightbox grid with slideshow functionality on a third party website for linking to PICTURESANDBOX.

### DETAILED DESCRIPTION

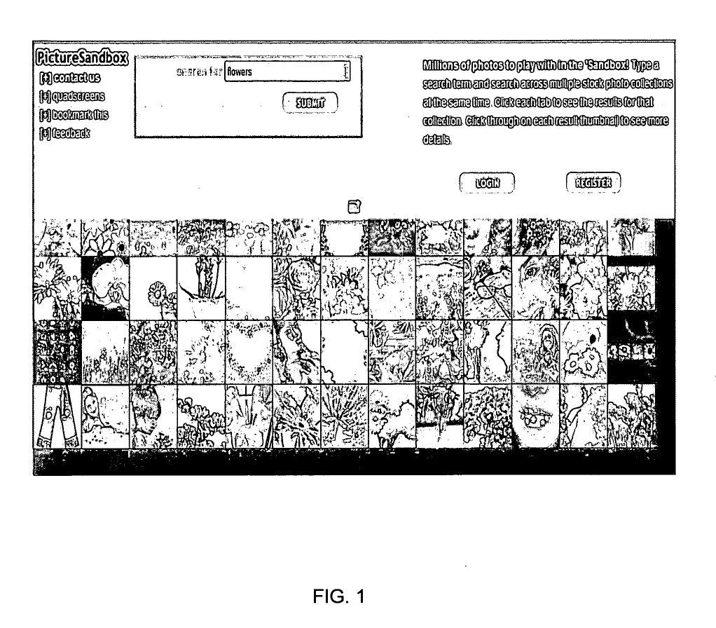

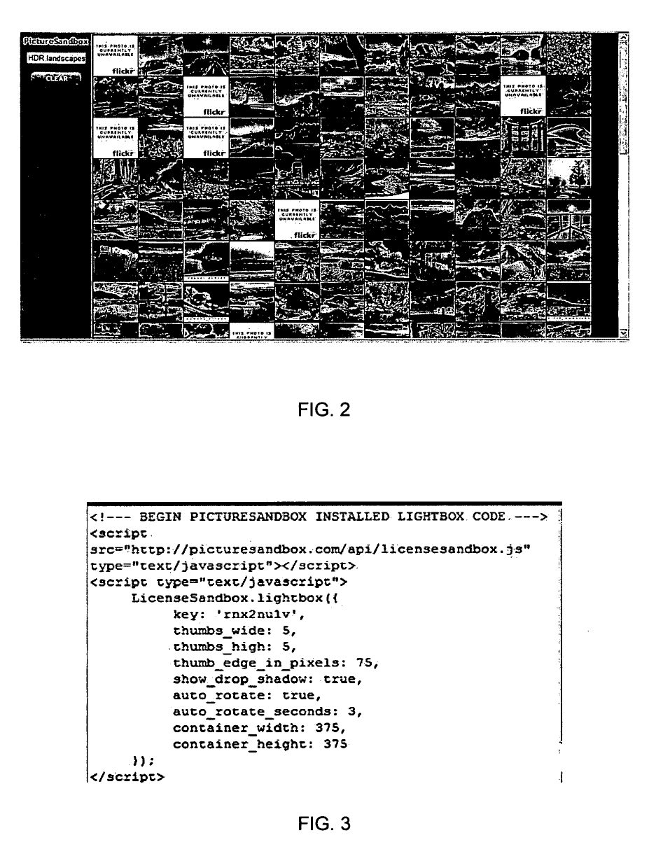

PICTURESANDBOX may operate as an online stock photography repository and/or may provide functionality to access and search other online repositories, such as FLICKR. PICTURESANDBOX may be a publicly-accessible web site operating on the Internet. FIG. 1 shows an exemplary search page for PICTURESANDBOX that may be used to enter search terms and view corresponding digital asset or image results. FIG. 2 shows a variety of available images on PICTURESANDBOX, where the images may include like/dislike ratings of other users of PICTURESANDBOX. FIG. 3 shows code that may be employed by third party website for linking to PICTURESANDBOX and displaying lightbox images and other PICTURESANDBOX functionality.

PICTURESANDBOX functionality may be built entirely in AJAX using the LAMP stack solution of software solutions. Such functionality includes:

multi-parameter search with negative keywords (for example, the search term “flowers -bees” would operate as “flowers minus bees” and return images of flowers that do not include bees);

saved searches with roll-back functionality that allows a user to get back to where previous image research had ended;

sharing “lightboxes” of stored digital assets with “like” and “dislike” ratings, allowing users to provide feedback on available digital assets;

automatic and bulk watermarking of all original images uploaded to Picture Sandbox by image owners, with automatic license generation;

automatic market-pricing for royalty bearing or royalty free image licenses, along with archiving of licenses for public inspection;

installable lightbox grids and slideshows for marketing and publicity of images on third party websites.

For image owners who have already posted their work to a third party online repository to list their images for sale, will need to

1. register an account with PICTURESANDBOX;

2. validate they own and control a username with the third party online repository by adding PICTURESANDBOX as a contact, or the like; and

3. tag the images they want to sell with metadata such as “PictureSandbox:price=auto” or “PictureSandbox:price=24.95” where “auto” means that PICTURESANDBOX sets the price based on stored pricing algorithms that take into account historical market transactions to identify market-clearing prices.

PICTURESANDBOX digital watermarks each instance of a digital asset uploaded from an image owner. This allows PICTURESANDBOX to reproducibly determine if this instance of an image is the licensed one (or not) by recreating the digital hash using the same inputs—e.g. the pixel data of image, the date/time stamp of the image, owner information, and other metadata. By comparing a generated hash of an image to stored hash values of existing licensed images, then the legitimacy of each image can be confirmed for purposes of copyright and the like (for example, a hash value of a new image must be unique from any other stored image to be legitimate).

Since two photos taken from the same vantage point at roughly the same time of day (lighting) look practically identical, there is no way to prove a photographer took a particular digital picture versus someone else who took a similar one, leaving the possibility of inadvertent copyright infringement litigation. Previously with films and the like, the real owner could simply show the original film or slide to prove they took the photo, but this is not possible with digital photography. However, this problem may be alleviated by adding a unique code and date/time stamp to the picture when it is taken and combining it with a unique code associated with each individual camera or other equipment used to generate the image, the owner can uniquely prove from which camera the photo came. Accordingly, the owner of that digital camera can prove they took the picture and provide additional metadata like date and time taken.

When a photo is purchased from PICTURESANDBOX, various license information may be embedded into the pixel data of the photo. This license data may include the hash value described above, and may also include all the other metadata. This data not only proves the authenticity of the original photo but also indicates the license information directly, for example, who licensed it, when it was licensed, characteristics of the photo like pixel dimensions, and the like. Accordingly, this information can be used to detect whether or not a digital asset has been altered.

On occasion, a dispute may arise regarding the copyright of the image or the validity of a corresponding license using the information from above, such as when the hash and the license information embedded in the image pixel data is questioned. In such cases, PICTURESANDBOX can detect whether the image has been altered, whether it is the original (by comparing to the hash generated when the image was submitted by the owner), and whether the license is valid, by inspecting the license data and comparing it to the stored information for the image, along with the information embedded in the licensed image. For example, since the license information is embedded into the pixel data of the licensed image it will have a detectably larger file size than the original. All of these details may be used to verify the licensed image.

PICTURESANDBOX may operate to receive and forward licensing revenues from a stock digital asset to the proper owner. PICTURESANDBOX may keep a portion of the revenues as a commission.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for storing and licensing digital assets, comprising:
receiving a digital asset from an owner;
generating a hash value of the digital asset based on at least one of pixel values and metadata of the digital asset, wherein the metadata includes a unique code corresponding to at least one of a time the digital asset was created and an identification of the equipment of the owner used to generate the digital asset;
comparing the hash value to hash values of other stored digital assets; and
accepting the digital asset for licensing when the hash value is unique.

2. A method for licensing digital assets, comprising:
receiving a digital asset from an owner;
generating a hash value of the digital asset based on at least one of pixel values and metadata of the digital asset, wherein the metadata includes a unique code corresponding to at least one of a time the digital asset was created and an identification of the equipment of the owner used to generate the digital asset;
embedding at least the hash value in the digital asset; and
licensing the digital asset.

3. A method for storing and licensing digital assets, comprising:
receiving a digital asset from an owner;
generating a hash value of the digital asset based on at least one of pixel values and metadata of the digital asset, wherein the metadata includes a unique code corresponding to at least one of a time the digital asset was created and an identification of the equipment of the owner used to generate the digital asset;
comparing the hash value to hash values of stored digital assets; and
validating the digital asset based on said comparing.
